(19) United States
(12) Patent Application Publication
(10) Pub. No.: US 2011/0141465 A1
(43) Pub. Date: Jun. 16, 2011

(54) Light-Guiding Flow Cells And Analytical Devices Using The Same

(75) Inventors: Anthony Jeannotte, foxborough, MA (US); Michael J. Leveille, Northbridge, MA (US); Frank Denecke, Mendon, MA (US)

(73) Assignee: WATERS TECHNOLOGIES CORPORATION, Milford, MA (US)

(21) Appl. No.: 12/991,765

(22) PCT Filed: May 20, 2009
(86) PCT No.: PCT/US2009/044633

§ 371 Date: Mar. 3, 2011

Related U.S. Application Data
(60) Provisional application No. 61/055,241, filed on May 22, 2008.

(51) Int. Cl. G01N 1/10

(52) U.S. Cl. 356/246

(57) ABSTRACT

A flow cell for a photometric device includes a module having a body with a distal face defining an annular channel. The body also defines an axial central passage and an axial flow channel. A second module has a body with a proximal face defining an annular channel. The second body also defines an axial flow channel in fluid communication with the first axial flow channel. A light guiding member is within the central passage for exposing a fluid in the flow channels of the modules. An assembly seals an interface between the distal and proximal faces such that the fluid does not leak from the flow channels. The assembly has a metal gasket between the distal and proximal faces, the metal gasket defining a flow path between the flow channels, a first sealing member in the first annular channel and a second sealing member in the second annular channel.

### CROSS-REFERENCE TO RELATED APPLICATION

This application claims priority to U.S. Provisional Patent Application No. 61/055,241, filed May 22, 2008, the entire contents of which are incorporated herein by reference.

### FIELD OF INVENTION

The subject technology relates to fluid analysis assemblies using flow cells in analytical fluid chemistry applications such as spectrophotometry. More specifically, the subject technology relates to improved devices and methods for fabricating and sealing flow cells.

### BACKGROUND OF THE INVENTION

One type of conventional flow cell is described in U.S. Pat. No. 6,526,188 (the '188 patent). The major components of the '188 patent cell include: a module containing at least one optical fiber that transports light from a remote light source; a second similar module incorporating a conduit made of TEFLON® AF 2400 amorphous fluoropolymer (Dupont); and a third module that contains an optical fiber that collects light that has been transmitted through the conduit.

Alternatively, in the case of a window terminating the flow cell, the fluid path is incorporated into the module containing the fluoropolymer conduit. These approaches use PEEK™ polyetheretherketone (Victrex PLC, Lancashire, UK) as the injection moldable adhesive to form the various modules. PEEK™ polyetheretherketone is a suitable material because it has some compliancy so that the modules can, after suitable registration, form a flow cell capable of withstanding substantial pressures. Other known variations include a metal body containing the conduit and a metal housing for the module containing the fiber optic and capillary lines. The optical throughput efficiency of this cell is dependent upon the spatial registration of the modules. The tradeoff is low optical losses at the expense of demanding manufacturing specifications for the molded parts. Minimum separation between the optical fiber and light guiding fluid conduit is important when considering the efficient transfer of radiation from one light-bearing conduit to another.

One significant disadvantage of prior art flow-cell design is the potential for introducing light into the walls of the light guiding conduit. It is well known that such light can result in reduced dynamic range in quantifying analyte levels. That is, not all the light, which is received by the detector has passed through the fluid sample. This unwanted radiation is known as stray light.

Another conventional flow cell is disclosed in U.S. Pat. No. 7,298,472 (the '472 patent). The '472 patent discloses a flow cell assembly consisting of the known modules described above, however, in certain instances, metal is substituted for PEEK™ polyetheretherketone as the material of construction. The fluidic and optical conduits of the '472 patent are secured within the metal modules by different techniques. With regard to the fluidic conduits, PEEK™ tubing critically sized to corresponding undersized metal holes in the metal modules are used. As the PEEK™ tubing is pulled through these holes, it is necked down and remains under compression by the resulting interference fit.

Alternatively, the amorphous-fluoropolymer optical conduit is encased within another compliant TEFLON® tube, which as an assembly is pulled through another central hole of critical size within the flow cell module. This approach, in which a succession of interference fits are used to secure tubing members within the flow cell module, was earlier employed in U.S. Pat. No. 6,526,188 which discloses that the TEFLON® AF tube is accurately located within a PEEK™ body (or PEEK™ tube which itself is secured by an interference fit within a metal body) by locating it within an intermediate tube of complementary dimensions. This intermediate tube material can be PEEK™ material or other chemically inert materials such as a known fluorinated hydrocarbon (e.g., TEFLON® PFA perfluoroalkoxy polymer or TEFZEL® ethylene tetrafluoroethylene (ETFE) fluoropolymer (DuPont)).

In the '472 patent, a compliant intermediate gasket has etched features establishing the fluidic connection between the fluid conduits and the central amorphous-fluoropolymer light guiding tube. Whereas in the '188 patent, the means for establishing the fluidic connection between the fluid conduits and the central light guiding tube is accomplished by creating a connecting channel at the end surface of the cell body module. In the '472 patent, an etched trench in the intermediate gasket is created that extends from an off-center hole to a centrally located hole whose aperture matches that of the lumen of the amorphous-fluoropolymer conduit.

Fluid-connecting etched trenches are well-known for example in the field of planar fluidic circuits. The aperture-matching requirement is again needed to prevent stray light from entering the wall of the amorphous fluoropolymer tubing. A compliant gasket is needed to form the hydraulic seal between the otherwise hard, non-resilient surface of the metal modules or the hard exit window terminating the flow cell. The compliant gasket is formed either from a single material having the requisite compliancy, such as KAPTON® polyimide film (available from DuPont Electrical Technologies of Circleville, Ohio) or another suitably coated metal substrate. In the case of the known naturally compliant gasket, the required features (e.g., holes, passageways) are etched into the material itself, whereas for the overcoated metal gasket only the metal is etched. The compliant material is later deposited.

As discussed above, the addition of a compliant material to an etched metal gasket is also well-known in the art. Although a compliant gasket offers advantages in certain cases, there are inherent problems with this approach. First, the naturally compliant gasket affords limited material choices when consideration is given to methods for fabricating the actual features or fluid passageways into this form of gasket. For example, although native KAPTON® polyimide film can be configured with such features, its optical transmission properties are such as to render it useless for preventing light of wavelengths longer than about 300 nm from entering the walls of the light guiding conduit, thereby leading to stray light. This amount of stray light would be unacceptable for applications requiring analyte detection within the 190-800 nm range of wavelengths and longer.

A metal gasket overcoated with a compliant material largely overcomes the stray light problem. However new design issues are introduced. The first of these is the fill-in factor associated with any overcoating process. In other words, the cross-section profile of the added layer cannot be expected to match that of the compliant metal substrate. As a result, the dimensional characteristics of fine features such as holes or etched channels are modified. Specifically, such dimensions become smaller in some proportion to the thickness of the coated layer. In cases where fill-in is objectionable, the overcoated material within and adjacent the central thru-hole has to be removed, for example, by subsequent laser ablation techniques, which adds cost in terms of production time and yield. Although a thinner coating would appear to solve this problem, there is a practical limitation on how thin this added resilient layer can be made and still effect the necessary hydraulic seal.

A second problem with known overcoated gaskets is the finite thickness of the compliant gasket. The efficient transfer of light radiation from the input fiber to the lumen in the amorphous fluoropolymer and again, from the lumen to the exit module, depends upon the thickness of the gasket. It can be appreciated that as gasket thickness increases less light is transferred into and out of the lumen, thereby compromising analyte detection.

### SUMMARY OF THE INVENTION

The subject technology relates to devices and methods for constructing flow cells for the analysis of small samples in solution. The subject technology includes sealing means for containing a high-pressure fluid and facilitating the efficient transfer of radiant energy through the flow cell. Flow cells of high optical throughput and low internal volume are contemplated by the subject technology, with particular application to flow cells, which employ light guiding means.

One advantage of the subject technology is the modular flow cell having high optical throughput with efficient transfer of radiant energy between flow cell modules while minimizing stray light. Hydraulic seals are provided herein, such as O-ring seals, eliminating the need for resiliently coated metal gaskets.

Another advantage of the subject technology is the use of precision etched metal discs whose accurately etched apertures and channel dimensions are preserved and whose thickness is minimized for optimum transmission of radiant energy between flow cell components, without the need for additional processing steps. It is an object of the subject technology to utilize cost effective assembly and fabrication processes for simplifying flow cell construction.

An additional advantage of the subject technology is an alternative means for sealing of flow cell modules or components constructed from rigid materials not involving resiliently-coated metal gaskets suitable for use with a broader range of lumen diameters, particularly to those having diameters less than about 0.1 mm (such lumens preferably being defined by an amorphous fluoropolymer, such as TEFLON® AF 2400 amorphous fluoropolymer, whose refractive index is less than that of a sample fluid in the lumen.)

It is another object of the subject technology to provide an alternative means for securing an optical fiber conduit within a flow cell module.

The subject technology is directed to a flow cell for a photometric device including a first module having a first body with a distal face defining a first annular channel. The first body also defines an axial central passage and at least one axial flow channel. A second module has a second body with a proximal face defining a second annular channel. The second body also defines at least one axial flow channel in fluid communication with the at least one axial flow channel of the first module. A first light guiding member is disposed within the axial central passage for exposing a fluid passing between the flow channels of the first and second modules to a desired wavelength range of light. To analyze the fluid, a second light guiding member e.g. TEFLON® AF, is disposed within the second module, and provides the remaining light from the first light guiding member to a detector outside of the flow cell. An assembly seals an interface between the distal and proximal faces such that the fluid does not leak from the flow channels. The assembly has a metal gasket between the distal and proximal faces, the metal gasket defining a flow path between the flow channels, a first compliant sealing member in the first annular channel as well as a second compliant sealing member in the second annular channel.

The flow cell of the subject invention further provides a first body that defines first and second axial flow channels and the second body having a second distal face defining an annular channel. The second body also defines first and second axial flow channels in fluid communication with the first and second axial flow channels of the first body, respectively. The flow cell may further include a third module having a distal face and a third proximal face defining an annular channel and a second assembly for sealing an interface between the distal and proximal faces of the second and third modules, respectively. The second assembly having a second metal gasket between the distal and proximal faces, the second metal gasket defining a second flow path between the first and second axial flow channels of the second body, a third compliant sealing member in the annular channel of the second distal face, and a fourth compliant sealing member in the annular channel of the third module. The third module may be a window or lens module.

The subject technology provides a method for securing the fiber whereby a collar is overmolded onto the optical fiber. The collared assembly is then pressed into a receiving bore of the corresponding flow cell module without imparting any direct stresses into the fiber. In this way, known low-cost manufacturing methods (e.g., molding, pressing) can be utilized.

One embodiment of the subject technology comprises a flow cell for a photometric device including a first module having a distal face defining a first annular channel. A second module has a proximal face defining a second annular channel and a light guiding member disposed within a central passage for exposing a fluid to a desired wavelength range of light. An assembly for sealing at least one flow channel is defined between the distal and proximal faces. The assembly comprises a metal gasket defining holes in fluid communication with the at least one flow channel. A first compliant sealing member is in the first annular channel for sealing a proximal face of the metal gasket and a second compliant sealing member is in the second annular channel for sealing a distal face of the metal gasket. The metal gasket may be etched to form the at least one flow channel. The first and second compliant sealing members may be selected from oval rings, circular rings, oval rings with flats, and square rings having rounded edges, or fabricated from so-called form-in-place resilient materials.

In another embodiment of the subject technology, a flow cell for a photometric device includes a first module having a distal face with a compliant coating selectively applied around a central passage. A second module has a proximal face with a compliant coating selectively applied thereto and a first light guiding member is disposed within the central passage for exposing a fluid to a desired wavelength of light. The flow cell further comprises a metal gasket assembly for sealing at least one flow channel defined between the distal and proximal faces. The metal gasket defines holes in fluid communication with the at least one flow channel.

In still another embodiment of the subject technology, a light guiding member for a flow cell includes an optical fiber shaft defining a cavity having a cladding layer for confining light within the shaft. A buffer layer is overmolded onto the cladding layer for providing structural integrity to the shaft and a plug portion is overmolded on the buffer layer at a top portion of the shaft for providing increased friction between the shaft when seated in a receiving bore of a flow cell. The optical fiber shaft defines a lumen, and the overmolded plug portion may be fabricated in a tapered dowel pin shape or a substantially conical shape.

In another embodiment of the subject technology, a flow cell for a photometric device includes a first module having a distal face defining a first annular channel. A second module has a proximal face defining a second annular channel, wherein the distal and proximal faces are sealed by a sealing member between the first and second annular channels. A first light guiding member is disposed with the first and second annular channels for exposing a fluid to a desired wavelength of light. The compliant sealing member may be an oval ring, a circular ring, an oval ring with flat sides or a square ring having rounded edges, or fabricated from so-called form-in-place resilient materials.

### BRIEF DESCRIPTION OF THE DRAWINGS

These and other features and advantages of the present invention will become more apparent from the following detailed descriptions taken in conjunction with the accompanying drawings wherein like reference characters denote corresponding parts throughout the several views, and wherein:

FIG. 1 is a side view of a flow cell assembly, in accordance with an embodiment of the invention;

FIG. 2A is an exploded perspective view of some components of the flow cell assembly of FIG. 1, viewed from below;

FIG. 2B is an exploded perspective view of some components of the flow cell assembly of FIG. 1, viewed from above;

FIG. 3 is an exploded side view of the cell assembly;

FIG. 4A is a top view of an etched gasket;

FIG. 4B is a bottom view of the etched gasket of FIG. 4A;

FIG. 5A is a top view of another etched gasket;

FIG. 5B is a bottom view of the etched gasket of FIG. 5A;

FIG. 6A is cross-sectional view of a gasket as shown in FIG. 4A;

FIG. 6B is a cross-sectional view of a gasket as shown in FIG. 4a having an etched channel and a tapered central thru-hole;

FIG. 7 is a graph depicting dependence of optical throughput on gasket thickness;

FIG. 8 is a longitudinal cross-sectional view of a flow cell assembly according to a second embodiment utilizing sealing films applied to the facing surfaces of the flow cell modules;

FIGS. 9A and 9B are detailed cross-sectional views illustrating another alternative means for masking the exit end of the flow cell in which an opaque layer is applied to the flow cell window module;

FIG. 10 is a longitudinal cross-sectional view of an optical fiber with over-molded sealing feature;

FIG. 11 is a longitudinal cross-sectional view illustrating a flow cell module housing and related parts in particular the use of a lobed washer as an improved means for preventing rotary motion between flow cell module components as the components are put under axial stress to effect fluidic sealing; and

FIG. 12 is a front view of the lobed washer of FIG. 11.

### DETAILED DESCRIPTION

The present invention overcomes many of the prior art problems associated with flow cells. The advantages, and other features of the technology disclosed herein, will become more readily apparent to those having ordinary skill in the art from the following detailed description of certain preferred embodiments taken in conjunction with the drawings which set forth representative embodiments of the present invention and wherein like reference numerals identify similar structural elements.

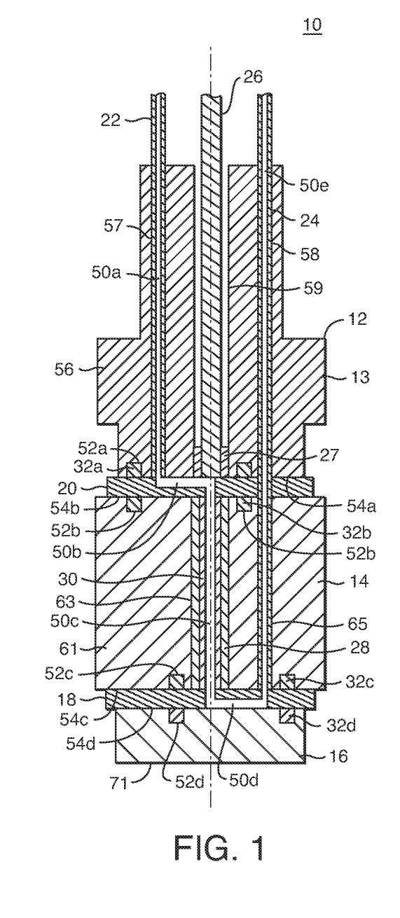

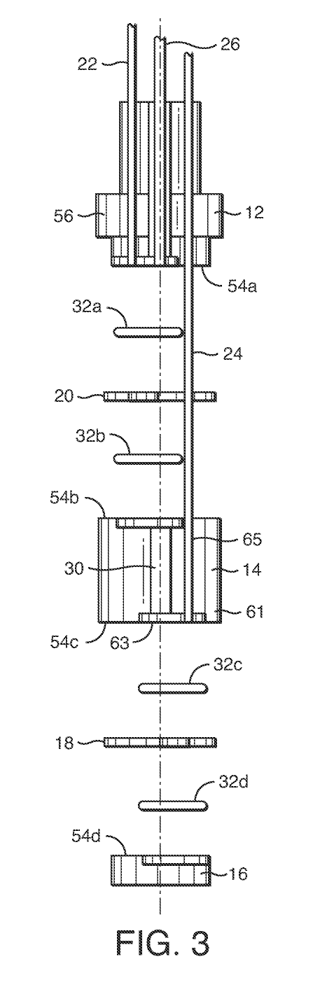

Referring now to FIGS. 1, 2A, 2B and 3, a flow cell sub-assembly 10 according to the subject technology includes the main modules 12, 14 and 16. Interposed between modules 12 and 14 and again between modules 14 and 16 are etched metal gaskets 20 and 18, respectively, which establish continuity of flow paths and permit the efficient transfer of light between the modules. Hydraulic sealing of flow paths 50a-50e is accomplished with O-rings 32a-32d located within annular grooves 52a-52d fabricated into the appropriate end faces 54a-54d of these modules 12, 14 and 16.

The use of O-ring seals 32a-32d in the subject technology is driven by a fundamental need to minimize the separation between the main modules 12, 14 and 16 in order to optimize the transfer of radiant energy thru the flow cell sub-assembly 10, simultaneously preventing light from entering the wall of a light guiding member 30. The optical fiber 26 delivers the light to the waveguide 30 which has transparent walls. The central hole in the gasket 20 prevents light that leaves the optical fiber 26 from getting into the walls of the waveguide 30. The core diameter of the optical fiber can be made larger than the gasket's central hole to ease alignment requirements. At the other end of light guiding member 30, the central hole in the gasket 18 is employed to prevent any light which may have unintentionally entered the walls of the light guiding member 30 from reaching an optical collection system or detector outside of the flow cell.

The top module 12 is comprised of a body 56 having a shoulder 13 and defining two channels 57 and 58 having fluid transmitting members 22 and 24, respectively. The shouldered body 56 also defines a third channel 59 containing the optical conduit or fiber 26 sealed into the top module 12 by means of an overmolded feature 27. O-ring 32a is used to provide a fluidic seal. Fluid line 24 passes through the top module 12 while fluid line 22 is sealed within the top module 12 via an interference fit at the distal end or face 54a. The channels 57, 58 and 59 terminate flush with the distal face 54a of the shouldered body 56.

The middle module 14 consists of a tubular body 61 having a central axial passage 63 with a light guiding tubular member 30 disposed therein. The tubular member 30 is surrounded by an intermediate tube 28 which has an outer surface in intimate contact with the central passage 63 and an inner surface in intimate contact with the tubular light guiding member 30. The tubular member 28 is chosen from chemically inert materials such as perfluoroalkoxy polymer or other suitable thermoplastics such as PEEK™ polyetheretherketone or TEFZEL® fluoropolymer, while tubular light-guiding member 30 is preferably formed from a material that supports light guiding, such TEFLON® AF amorphous fluoropolymer or any other suitable material consistent with the requirement that for efficient light guiding the refractive index of light guiding member 30 must be less than that of the fluid medium passing through this member.

Fluidic line 24 is also fluidically sealed within an off-axis passage 65 in the middle module 14 by an interference fit similar to that employed for securing the fluid line 22 within the top module 12. Middle module 14 is shown configured with O-rings 32b and 32c set in respective annular grooves 52b and 52c in upper (e.g., proximal) and lower (e.g., distal) faces 54b and 54c.

The lower module 16 has a disc shaped body 71 of transparent material to form a simple window. The disc shaped body 71 also has an annular groove 52d in an upper face 54d equipped with an O-ring 32d. The disc shaped body 71 may be formed of fused silica or other materials that are transparent to the wavelengths of light passing through the flow cell. The disc-shaped body 71 is optionally shaped to function as an optical lens; for example, the lower face of the body 71 is optionally curved, such as spherical. O-ring materials are chosen to be compatible with the broad range of fluids employed in high pressure liquid chromatography (HPLC), ultra-high pressure liquid chromatography (UPLC), capillary electrophoresis (CE) or even other non-chromatographic environments. These materials include, for example, materials such as polytetraflouroethylene (PTFE) and KALREZ® elastomer (available from Dupont), or any other suitable material.

Light guiding member 30 is secured within tubular member 28, which has an outer diameter slightly larger than the corresponding central passage 63 in the middle module 14. The member 30 with tubular sleeve 28 form an assembly, which is secured within module 14 by virtue of an interference fit between tubular member 28 and central passage 63. The fluidic sample can enter the flow cell sub-assembly 10 via either conduit 22 or 24. Likewise, probe radiation from an external light source (not shown), such as a deuterium lamp may be launched into either the optical fiber 26 or focused through the lower module 16 onto the lumen of the light guiding member 30. As noted above, etched gaskets 20 and 18 establish fluidic connections between the three modules 12, 14 and 16 while also serving to mask light from entering the annular sidewall of the tubular member 30.

Some alternative embodiments of a flow-cell subassembly include a window or lens module at both ends of a subassembly. For example, the subassembly 10 is optionally modified to include an upper module having a body of transparent material to form a window or shaped to provide a mirror.

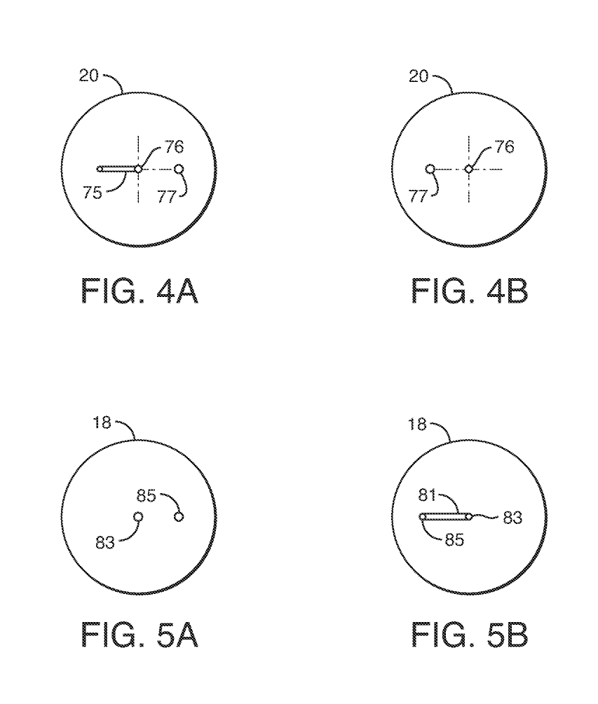

Referring now to FIG. 4A, a detailed top view of the gasket 20 is shown. The gasket 20 has a partially etched channel 75 terminating in a centrally-located thru-hole 76. The etched channel 75 does not pass through the gasket 20. Thus when assembled, the channel 75 connects fluid paths 50a-50b and then to 50c, which is located within light guiding member 30 as light exiting the optical fiber of the top module 12 at interface 54a passes therein. The gasket 20 also contains an off-center thru-hole 77 for providing clearance for the fluid line 24.

Referring now to FIG. 4B, a detailed bottom view of the gasket 20 is shown. Both thru-holes 76 and 77 are evident but the channel 75 is not because the channel 75 is not etched through the gasket 20. The dual functionality of fluidic connection and light masking is noted in U.S. Published Patent Application No. US2005/0078308 and Patent Cooperation Treaty Patent Application No. PCT/US2005/029204.

The etched features such as the channel 75 are designed to minimize unswept volume, which can cause dispersion (or broadening) of chromatographic peaks. This is particularly troublesome when the total tubular volume of the tubular member 30 is much below 0.3 microliters. Accordingly, for such low volume cells, only a partially etched channel 75 is desirable.

Referring now to FIGS. 5A and 5B, top and bottom detailed views of the gasket 18 are shown. The gasket 18 also has an etched channel 81 terminated by two thru-holes 83 and 85 so the fluid may be swept past the window 16 before entering (or exiting from) fluid line 24. It is noted that the gaskets 18 and 20 could be identical in the form of gasket 18 and the flow cell sub-assembly 10 would perform adequately if the unswept volume was judged small in comparison with the tubular volume of light guiding member 30.

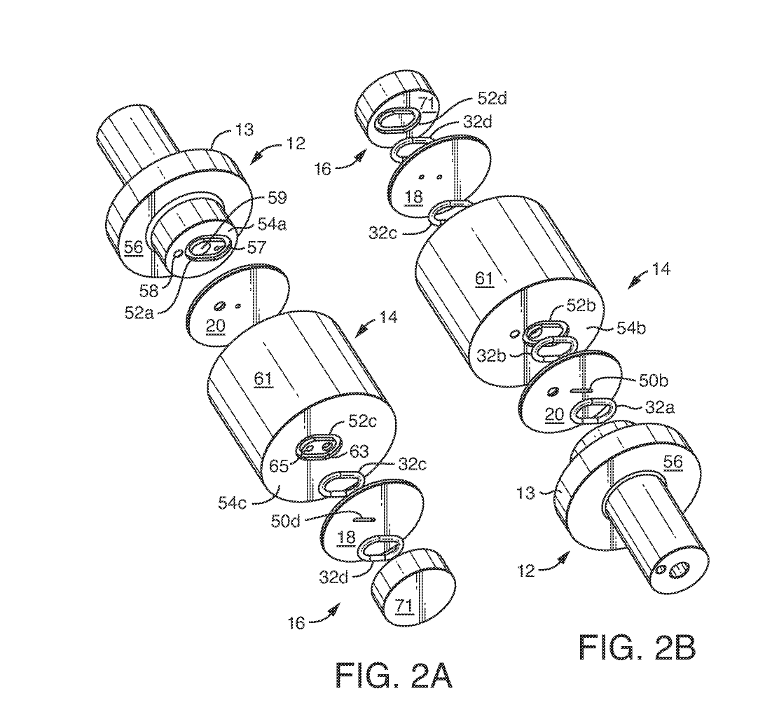

Referring again to FIG. 2, the exploded perspective view of flow cell sub-assembly 10 shows that the O-rings 32a-32d need not be circular and preferably are oval or of a ‘racetrack’ shape for minimizing the overall sealed area. It should also be appreciated that although the cross-sectional views of these O-rings 32a-32d are shown as circular in reality their actual wall thickness is chosen to substantially fill the annular groove profile in order to eliminate potential dead volumes when fully compressed. Further, the module faces 54a-54d are finished to a requisite flatness and surface roughness for further minimizing interfacial voids at the contacting area between each module and respective gasket. In one embodiment, the module faces 54a-54c undergo an optical polish process before incorporation into flow cell sub-assembly 10. By definition both faces of module 16 must possess the required flatness to function as optical windows. The annular grooves 52a-52d may be fabricated through standard machining operations, etching, laser machining and the like, also including methods such as the Sol Gel process for creating such features in fused silica.

Light is delivered to the lumen of tubular member 30 via optical conduit 26. The light carrying capacity or etendue, Eₒ, of the flow cell sub-assembly 10 is given by:

Eₒ=A_{f}·πNA²

where A_{f} is the cross-sectional area of the light guide's lumen and NA is the numerical aperture of the light beam within the lumen which equals the sine of the maximum half-angle of light sustainable by the fluid-filled lumen of light guiding member 30, which in turn depends upon the refractive index of light guiding member 30 and that of the fluid contained therein.

The optical fiber 26 delivers radiation of an angular extent to match the etendue of the liquid core light guide but not an excess in terms of NA as this can lead to undesirable RI effects. Accordingly, it is preferable to use an optical fiber whose diameter is larger than the AF lumen but whose NA, set by opto-mechanical elements external to the flow cell 10, matches that of the AF guide. The larger diameter of the optical fiber 26 in cooperation with the restricting central aperture of the gasket 20 has the benefit of relaxed alignment requirements between the fiber and AF conduits.

The excess light emerging from the optical fiber 26 is blocked by the central thru-hole 76 of the gasket 20. However, as the gasket thickness increases, the angular extent of the light passing into the AF lumen 30 is reduced, thereby leading to an optical underfilling of light guiding member 30. The effect of this underfilling or reduction in etendue can be estimated by noting that the conventional ray model of optics gives a satisfactory description of light transmission through a multimode light guide wherein the fluid core diameter is typically greater than 50 microns, e.g., 100 microns.

In this case, the efficiency of the transfer of radiant energy from the optical fiber 26 to the tubular member 30 with interposed gasket 20 may be treated by the following expression:

E′=∫∫(cos θ₁δA₁ cos θ₂δA₂/R²₁₂)

The subscript ‘1’ refers to the area within the exit (emitting) face of the optical fiber 26 and ‘2’ refers to the receiving area within the lumen diameter of AF lumen 30. R₁₂ represents the distance of a line connecting the center of each differential area and the cosine terms reflect the orientation of δA₁ or δA₂ relative to this line.

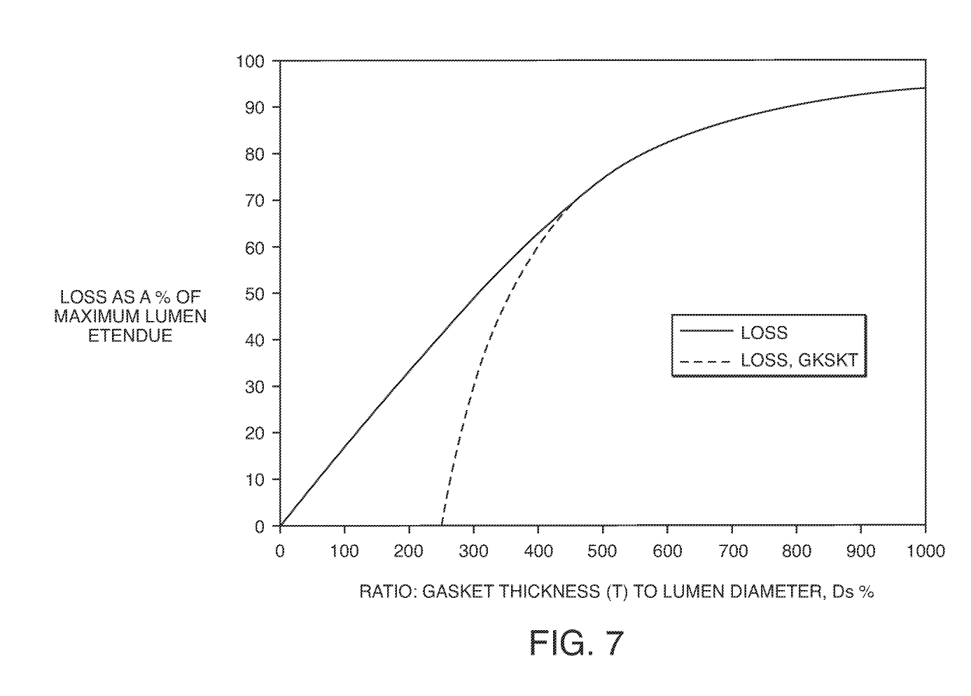

For an infinitely thin gasket, the above expression reduces to Eₒ. For a gasket of finite thickness, the above integration is carried out with results appearing in FIG. 7, wherein the beam has an NA of 0.275 (measured in air) leaving the fiber 26 and is launched into a fluid having a refractive index of 1.38, typical of aqueous-based mobile phases in the UV. The loss L in light carrying capacity expressed as a percentage of Eₒ is plotted as a function of the ratio, Q, between gasket thickness T and fluid lumen diameter Dₛ expressed as a percent. A ratio of 100% means that the gasket thickness T equals the lumen diameter Dₛ.

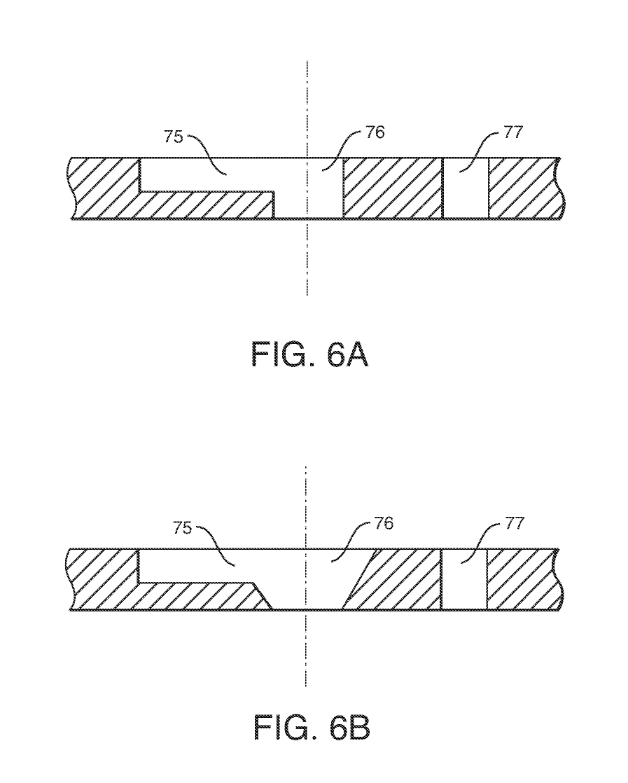

Physically, each elemental area within the lumen of 30 is capable of accepting a cone of light whose NA is in accordance with Eₒ. As gasket thickness increases, some portion of these cones are occulted by the edge of the central hole 76 of gasket 20 closest to the optical fiber. Eventually the maximum angle of acceptance by the light guide is controlled by the gasket itself. This situation is shown as the dashed line in FIG. 7. It may also be possible to etch or otherwise shape the gasket's 20 central hole 76 or 83 in such a manner that the surface is non-cylindrical but rather tapered or flared-out to a larger diameter at the interface region 54a. For example, FIG. 6A shows a cross-sectional view of the etched gasket 20 shown in FIG. 4A discussed above. The dotted vertical line indicates the view along the center line of a cylindrical central thru-hole 76 and etched channel 75. Alternatively, FIG. 6B shows a cross sectional view of the gasket 20 having a tapered or non-cylindrical central thru-hole 76. In this case, consideration must be given to the effect of the volume added by this operation relative to total sample volume of the lumen of member 30 as well as the increased hole diameter at 54a relative to the emitting diameter of member 26.

Because gaskets 20 and 18 are employed at each end of the AF lumen 30, the overall loss, assuming that light which successfully passes into the entrance face of the tubular member 30 completely fills its exit lumen, is multiplied. For example, for Q=100, the loss L≈17%. The level transmitted into the lumen is 83% but undergoes a further loss of 17% upon exiting the lumen for an overall exit transmission, Tₓ, of 0.83² or 69%.

This situation is further illustrated by the data in Table 1 below which compares total transmission levels for four different lumen sizes—all at constant gasket thickness—where total transmission level corresponds to that emerging from the exit end of the flow cell sub-assembly 10, exclusive of Fresnel losses which are common to all listed configurations. High overall transmission levels are desirable for good analytical sensitivity.

TABLE 1
Table of predicted cell transmission level, Tₓ

| Gasket Thickness, | Lumen Diameter | | | |
|---|---|---|---|---|
| T, inches | Ds, microns | Q, % | L, % | Tₓ, % |
| 0.008 | 400 | 50 | 8 | 85 |
| 0.008 | 250 | 80 | 13 | 76 |
| 0.008 | 100 | 200 | 33 | 45 |
| 0.004 | 100 | 100 | 17 | 69 |
| 0.002 | 100 | 50 | 8 | 85 |

Clearly low volume light guiding flow cells having lumen diameters on the order of 100 microns will experience unacceptable losses in light throughput using gaskets, which are otherwise suitable for larger lumen diameters. The addition of a compliant or resilient material to each side of a normally incompressible etched gasket will only exacerbate this loss. Therefore, a combination of an uncoated, precisely etched gasket and alternative sealing means imparted to the modules 12, 14 and 16 provides a path to the efficient transfer of light in small diameter fluid core light guides and fully useable for larger lumen diameters.

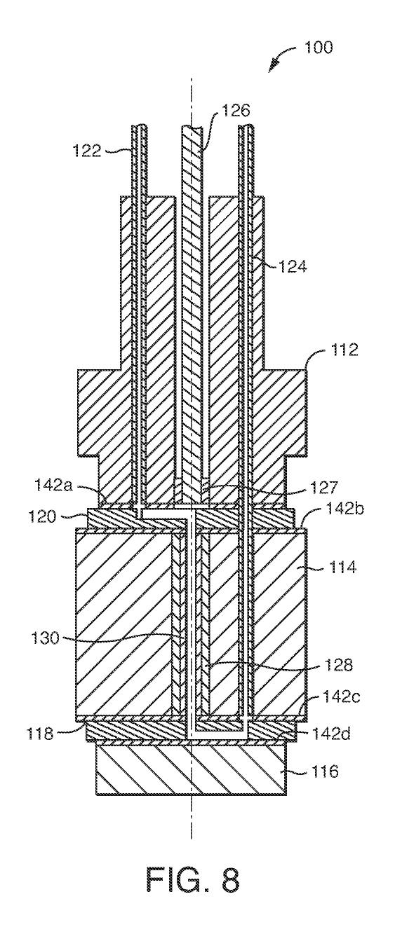

Referring now to FIG. 8, another embodiment of a flow cell sub-assembly 100 in accordance with the subject technology is shown. As will be appreciated by those of ordinary skill in the pertinent art, the flow cell sub-assembly 100 utilizes similar principles to the flow cell sub-assembly 10 described above. Accordingly, like reference numerals preceded by the numeral “1” are used to indicate like elements. The primary difference of the flow cell sub-assembly 100 in comparison to the flow cell sub-assembly 10 is the O-ring seals 32a-d are replaced with resilient coatings 142a-d separately applied to the corresponding faces 154a-d of the modules 112, 114 and 116.

The coatings 142a-d may be chosen from a variety of materials such as PTFE, PVDF, FEP, TEFLON® AF 2400 amorphous fluoropolymer, AF1600 Cytop, or other chemically inert materials. The coatings 142a-d may be applied through spin coating, vapor deposition or other well known techniques. Depending upon the optical properties of the coating, critical areas such as the emitting face of optical fiber 126 or window of lower module 116 may be masked-off. The coatings 142a-d may also be applied to the gaskets 118 and 120 as opposed to the modules 112, 114 and 116.

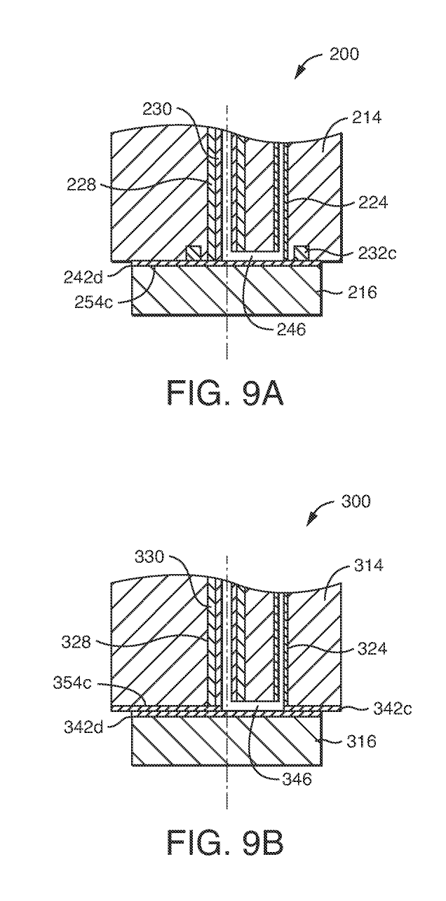

Referring now to FIG. 9A, another sealing means in a flow cell sub-assembly 200 according to the subject technology is shown, whereby the etched gaskets are replaced entirely. Again, the flow cell sub-assembly 200 utilizes similar principles to the flow cell sub-assemblies 10 and 100 described above. Accordingly, like reference numerals preceded by the numeral “2” are used to indicate like elements whenever possible.

The fluidic connection between modules 214 and 216 is a channel 246 formed in the corresponding face 254c of the middle module 214. An opaque coating may be applied to the window module 216 except in the central region which permits the unobstructed passage of radiant energy. Such coatings are well-known such as gold-over-chrome which is chemically inert. The fluid path is sealed against leakage with an O-ring 232c.

Referring now to FIG. 9B, another sealing means in a flow cell sub-assembly 300 according to the subject technology is shown, whereby an additional compliant layer 342c is utilized. Again, the flow cell sub-assembly 300 utilizes similar principles to the flow cell sub-assemblies 10, 100 and 200 described above and like reference numerals preceded by the numeral “3” are used to indicate like elements whenever possible. The additional compliant layer 342c is applied directly to the lower face 354c of the middle module 314 and no O-ring is required. As can be seen in FIGS. 9A and 9B, the separation between modules can be reduced by using compliant layers rather then gaskets.

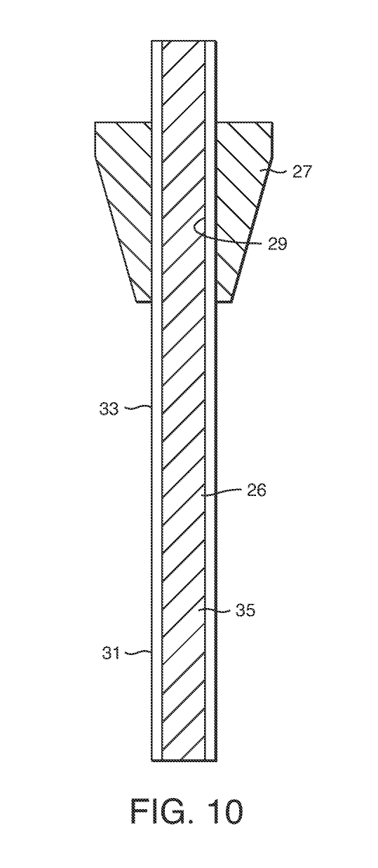

Referring now to FIG. 10, the optical fiber 26 is shown with an optional means for sealing the optical fiber 26 within top module 12. The improved sealing means utilizes an overmolded feature 27 on the optical fiber 26. In effect, the overmolded feature 27 resembles the shape of a tapered dowel pin. The overmolded feature 27 may be funnel-shaped and define a central opening 29 for receiving the optical fiber 26.

Molding permits accurate centration of the fiber along with consistent outside feature dimensions which permits for greater manufacturing yields. The relatively thin feature wall thickness means more uniform composition of molded material, thereby avoiding common molding defects such as internal voids. Although the receiving bore 59 in module 12 is shown as a single cross-section in FIG. 1, it is to be appreciated that the bore 59 extending upwards from the overmolded feature 27 (that is, moving away from the distal face of module 12) could be made smaller.

The optical fiber 26 has an outer buffer layer 31 surrounding a cladding layer 33, which surrounds the fiber core 35. The buffer layer 31 may be a KAPTON® film, which is bonded in place to prevent damage to the fiber core 35. The overmolded feature 27 may be PEEK™ material. The overmolded feature 27 may also have a different shape such as including a series of concentric ridges, be relatively thinner or thicker than shown, have a shallower draft and the like.

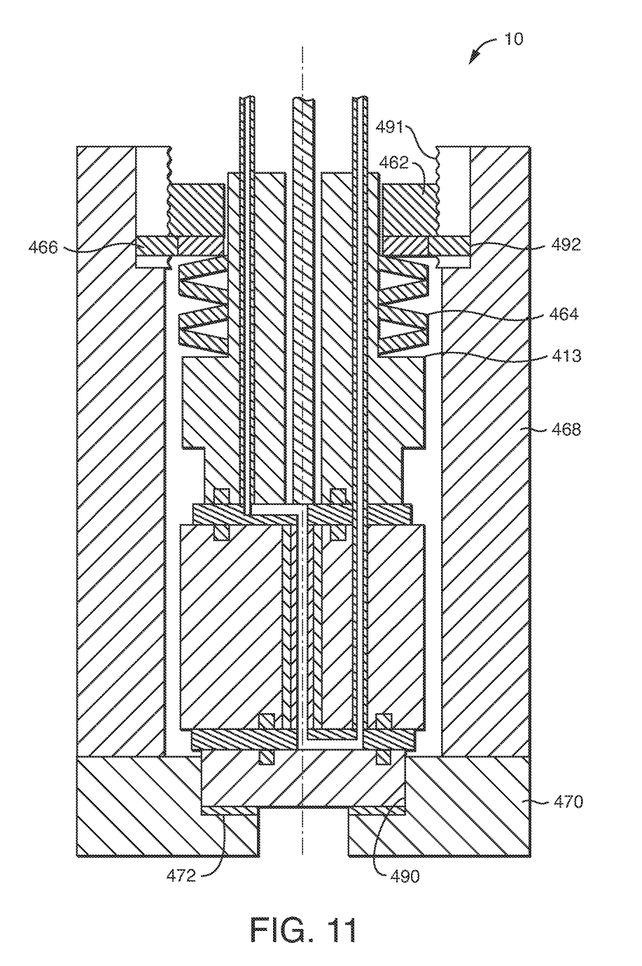

Referring now to FIG. 11, the flow cell sub-assembly 10 is shown within a housing 468 equipped with an end cap 470. A thin semi-compressible disc 472 serves as a buffer layer between lower module 16 and a receiving counterbore 490 in the end cap 470. The disc 472 accommodates any surface roughness of the end cap 470 as well as permitting the unrestricted alignment of the lower module 16 to the middle module 14.

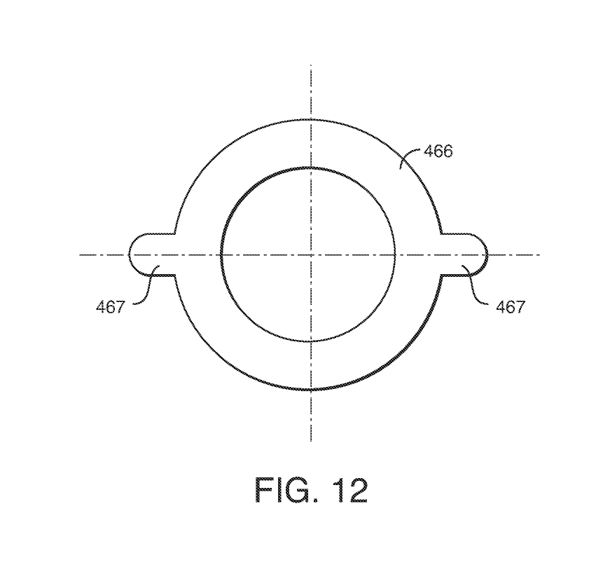

The flow cell sub-assembly 10 is sealed within the housing 468 through the use of a Belleville spring arrangement or stack 464 loaded onto the upper shoulder 413 of top module 12. The Belleville stack 464 is followed by a washer 466 with a shape as shown in FIG. 12. The washer 466 has opposing anti-rotation protrusions 467, which fit within hollows 492 formed in the housing 468. The washer 466 is placed between the Belleville stack 464 and a nut 462. The nut 462 engages threads 491 formed within the housing 468 such that the nut 462 is tightened to effect the overall pressure seal.

The anti-rotation washer maintains opto-mechanical alignment between the various modules and gaskets during tightening. As a result, the tightening process does not significantly impact overall light transmission which may occur due to relative rotations between the top module 12, gasket 20 and middle module 14. The Belleville stack 464 and anti-rotation feature of the washer 466 results in the tightening load being directed in a more fully axial direction with no or trivial change in overall cell energy.

Although the subject invention has been described with respect to preferred embodiments, those skilled in the art will readily appreciate that changes or modifications thereto may be made without departing from the scope of the subject invention as defined by the appended claims.

### INCORPORATION BY REFERENCE

The entire contents of all patents, published patent applications, and other references cited herein are hereby expressly incorporated herein in their entireties by reference.

1. An elongated flow cell for a photometric device comprising:
a) a first module having a first body with a distal face defining a first annular channel, the first body also defining an axial central passage and at least one axial flow channel;
b) a second module having a second body with a proximal face defining a second annular channel, the second body also defining at least one axial flow channel in fluid communication with the at least one axial flow channel of the first module;
c) a light guiding member disposed within the axial central passage for exposing a fluid passing between the flow channels of the first and second modules to a desired wavelength range of light; and
d) an assembly for sealing an interface between the distal and proximal faces such that the fluid does not leak from the flow channels, the assembly having:
i) a metal gasket between the distal and proximal faces, the metal gasket defining a flow path between the flow channels;
ii) a first compliant sealing member in the first annular channel; and
iii) a second compliant sealing member in the second annular channel.

2. The flow cell according to claim 1, wherein the light guiding member directs light into a portion of the flow path.

3. The flow cell according to claim 1, wherein the flow path is a first axial hole aligned with the axial central aperture and a channel extending radially outward from the first axial hole.

4. The flow cell according to claim 1, wherein the metal gasket is etched to form the flow path.

5. The flow cell according to claim 1, wherein said first and second compliant sealing members are selected from the group consisting of: oval rings; circular rings; oval rings with flats; square rings having rounded edges, and form-in-place gasketing.

6. The flow cell according to claim 1,
wherein:
the first body defines first and second axial flow channels; and
the second body has a second distal face defining an annular channel, and the second body also defines first and second axial flow channels in fluid communication with the first and second axial flow channels of the first body, respectively, and further comprising:
a third module having a third proximal face defining an annular channel; and
a second assembly for sealing an interface between the distal and proximal faces of the second and third modules, respectively, the second assembly having:
i) a second metal gasket between the distal and proximal faces, the second metal gasket defining a second flow path between the first and second axial flow channels of the second body;
ii) a third compliant sealing member in the annular channel of the second distal face; and
iii) a fourth compliant sealing member in the annular channel of the third module.

7. A flow cell for a photometric device comprising:
a) a first module defining a central passage and having a distal face with a compliant coating selectively applied around the central passage;
b) a second module having a distal face and a proximal face with a compliant coating selectively applied thereto, wherein the first and second module combine to define at least one flow channel for the fluid;
c) a light guiding member disposed within the central passage for exposing the fluid to a desired wavelength range of light; and
d) a metal gasket for sealing an interface defined between the distal and proximal faces.

8. The flow cell of claim 7, further comprising a third module having a compliant coating selectively applied thereto.

9. The flow cell of claim 8, wherein the third module is a window or lens module.

10. The flow cell of claim 7, wherein the metal gasket at least partially defines the flow path.

11. The flow cell of claim 7, wherein the light guiding member includes:
a) an optical fiber shaft defining a cavity having a cladding layer for confining light within the shaft;
b) a buffer layer overmolded onto the cladding layer for providing structural integrity to the shaft; and
c) a plug portion overmolded on the buffer layer at a top portion of the shaft for providing increased friction between the shaft when seated in a receiving bore of a flow cell.

12. The flow cell of claim 11, wherein the shape of the plug portion is selected from the group consisting of: a tapered dowel pin shape and a substantially conical shape.

13. The flow cell of claim 7, wherein at least a portion of a shape of a central hole within the metal gasket is flared-out.

14. An elongated flow cell for a photometric device comprising:
a) a first module having a distal face defining a first annular channel and a body defining a central passage;
b) a second module having a proximal face defining a second annular channel, wherein the first and second module define a flow path for fluid, the flow path being at least one axial channel of the first module in fluid communication with an etched channel in the distal face, which is in fluid communication with at least one axial channel of the second module;
c) a sealing member between the first and second annular channels; and
d) a light guiding member disposed within the central passage for exposing the fluid to a desired wavelength range of light.

15. The flow cell of claim 14, further comprising:
a window or lens module adjacent a distal face of the second module, wherein the proximal face defines an annular channel; and
a sealing member intermediate the window module and the distal face of the second module.

16. The flow cell of claim 15, further comprising:
a housing having an end cap adjacent the window or lens module for retaining the window or lens module;
a thin semi-compressible disc between the window or lens module and the end cap;
a Belleville stack loaded on a shoulder of the first module;
a nut for retaining the Belleville stack within the housing; and
a washer having an anti-rotation tab, the washer being between the Belleville stack and the nut such that the nut is tightened to effect the overall pressure seal.

17. A photometric device for analyzing a fluid comprising:
(a) a light source;
(b) a fluid source; and
(c) an elongated flow cell for receiving fluid from the fluid source, the elongated flow well comprising:
i) a first module having a first body with a distal face defining a first annular channel, the first body also defining an axial central passage and at least one axial flow channel;
ii) a second module having a second body with a proximal face defining a second annular channel, the second body also defining at least one axial flow channel in fluid communication with the at least one axial flow channel of the first module;
iii) a first light guiding member for receiving light from the light source, the first light guiding member being disposed within the axial central passage for exposing a fluid passing between the flow channels of the first and second modules to a desired wavelength range of light; and
iv) an assembly for sealing an interface between the distal and proximal faces such that the fluid does not leak from the flow channels, the assembly having a metal gasket between the distal and proximal faces, the metal gasket defining a flow path between the flow channels, a first compliant sealing member in the first annular channel, and a second compliant sealing member in the second annular channel.

18. The photometric device as recited in claim 17, further comprising a second light guiding member disposed within the second module for receiving a remaining light from the first light guiding member and providing the remaining light to a detector.

19. The photometric device as recited in claim 17, further comprising:
a window or lens module adjacent a distal face of the second module; and
a sealing member intermediate the window or lens module and the distal face of the second module.
